(19) United States
(12) Patent Application Publication
(10) Pub. No.: US 2014/0007007 A1
(43) Pub. Date: Jan. 2, 2014

(54) TERMINAL DEVICE AND METHOD OF CONTROLLING THE SAME

(71) Applicant: SAMSUNG ELECTRONICS CO., LTD., Suwon-si (KR)

(72) Inventors: Bo-ra LEE, Seoul (KR); Ji-hye CHUNG, Seoul (KR)

(21) Appl. No.: 13/926,043

(22) Filed: Jun. 25, 2013

(30) Foreign Application Priority Data
Jun. 27, 2012 (KR) 10-2012-0069318

(51) Int. Cl. G06F 3/0481

(52) U.S. Cl. CPC G06F 3/0481; G06F 3/04817
USPC 715/810; 715/764

(57) ABSTRACT

A terminal device is provided. The terminal device includes a user interface unit configured to receive a user's command for an application being executed, a storage unit configured to store the user's command input for the application according to an order of input, and a control unit configured to control the application to be automatically executed by sequentially applying the stored user's command when the application is terminated and then executed again.

### CROSS-REFERENCE TO RELATED APPLICATION

This application claims priority from Korean Patent Application No. 10-2012-0069318, filed on Jun. 27, 2012, in the Korean Intellectual Property Office, the disclosure of which is incorporated herein by reference in its entirety.

### BACKGROUND

1. Field

Apparatuses and methods consistent with exemplary embodiments relate to a terminal device and a method of controlling the same, and more particularly, to a terminal device which does not support multitasking and a method of controlling the same.

2. Description of the Related Art

In recent years, with the development of electronic technology, various kinds of terminal devices are provided to a user. In particular, the various terminal devices which have been currently released can fast process a large amount of data with the development of hardware and thus provide a multitasking function which execute two or more applications using one terminal device simultaneously.

However, some terminal devices can not often provide the multitask function due to restriction of a platform and the like. The terminal device, which basically uses a full screen and does not provide the multitasking function, has to terminate an application being executed and drive a desired application to be executed so as to perform task switching.

When the terminated application is driven again, to return the previous execution state, the same user's command has to be input repeatedly and it is difficult to share data between applications.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments are to provide a terminal device which does not multitask and provides the same function as a function supported by a multitasking terminal, and a method of controlling the same.

One or more exemplary embodiments are to provide a terminal device which does not support multitasking and supports data transfer between applications and a method of controlling the same.

According to an aspect of an exemplary embodiment, there is provided a terminal device. The terminal device may include: a user interface configured to receive a command of a user for an application being executed; a storage configured to store the command, input for the application according to an order of input; and a controller configured to control the application to be automatically executed by sequentially applying the stored command when the application is terminated and then executed again.

The controller may control the application to be automatically executed by sequentially applying the stored command when the application is terminated by execution of another application and then executed again.

The storage may store page loading information together with the command when a page loading operation is necessary according to the received command for the application, and the controller may check the stored page loading information, and control the application to be automatically executed by applying a next command of the user after the page loading operation is completed.

The storage may store a key input value when the command for the application is a key input and store a corresponding coordinate value when the command for the application is one of a pointing input and touch input.

The terminal device may further include a display configured to display an application execution screen. The controller may display an icon corresponding to at least one application previously executed at the display unit according to a preset event, and drive an application corresponding to an icon selected again when the user selects the displayed icon.

The controller may control the application to be automatically executed up to a state just before the application is terminated by sequentially applying the stored command.

The storage may store data information generated during the execution of the application, the data information being available during execution of another application.

The terminal device is configured not to support multitasking.

According to another aspect of an exemplary embodiment, there is provided a method of controlling a terminal device. The method may include: receiving a first command of a user for an application being executed; storing the first command input for the application according to an order of input; and controlling the application to be automatically executed by sequentially applying the stored first command when the application is terminated and then executed again.

The controlling may include controlling the application to be automatically executed by sequentially applying the stored first command when the application is automatically terminated by execution of another application and then executed again.

The storing may include storing page loading information together with the first command when a page loading operation is necessary according to the received first command for the application. The controlling may include checking the stored page loading information and controlling the application to be automatically executed by applying a next command of the user after the page loading operation is completed.

The storing may include storing a key input value when the first command for the application is a key input and storing a corresponding coordinate value when the command for the application is one of a pointing input and a touch input.

The method my further include displaying an icon corresponding to at least one application previously executed according to a preset event, receiving a second command of a user for selecting the displayed icon, and executing an application corresponding to the selected icon.

The controlling may include controlling the application to be automatically executed up to a state just before the application was terminated by sequentially applying the stored first command when the application is executed again.

According to an aspect of another exemplary embodiment, there is provided a terminal device, comprising: an interface configured to receive a command for an application being executed; a storage configured to store the command, which is input for the application; and a controller configured to control the application to be automatically executed, wherein the stored command is applied when the application is terminated and then executed again.

When the application is terminated and executed again, the controller may control the application to be automatically executed again by sequentially applying the stored command when the application is terminated by execution of another application.

The terminal device may be configured not to support multitasking.

According to another exemplary embodiment, there is provided a method of controlling a terminal device. The method comprises: receiving a first command for an application being executed; storing the first command received for the application; and controlling the application to be automatically executed by sequentially applying the stored first command when the application is terminated and then executed again.

The controlling may comprise controlling the application to be automatically executed by sequentially applying the stored first command when the application is automatically terminated by execution of another application and then executed again.

The method may further include storing data information generated during the execution of the application to be available during execution of another application. The terminal device may be a terminal device configured not to support multitasking.

As described above, according to the various exemplary embodiments, the same environment as an environment in which multitasking is supported in the terminal device configured not to support multitasking can be provided to the user, and data can be transferred between applications.

Additional aspects of exemplary embodiments will be set forth in the detailed description, will be obvious from the detailed description, or may be learned by practicing the exemplary embodiments.

### BRIEF DESCRIPTION OF THE DRAWING FIGURES

The above and/or other aspects will be more apparent by describing in detail exemplary embodiments, with reference to the accompanying drawings, in which:

FIG. 1 is a block diagram illustrating a configuration of a terminal device according to an exemplary embodiment;

FIG. 2 is a block diagram illustrating a configuration of a terminal device according to another exemplary embodiment;

FIG. 3 is a view illustrating an operation of a display unit according to an exemplary embodiment;

FIG. 4 is view illustrating an operation of a display unit according to another exemplary embodiment;

FIG. 5 is a view illustrating a method of controlling a terminal device according to an exemplary embodiment; and

FIG. 6 is a view illustrating a method of controlling a terminal device according to another exemplary embodiment.

### DETAILED DESCRIPTION OF EXEMPLARY EMBODIMENTS

Hereinafter, exemplary embodiments will be described in more detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

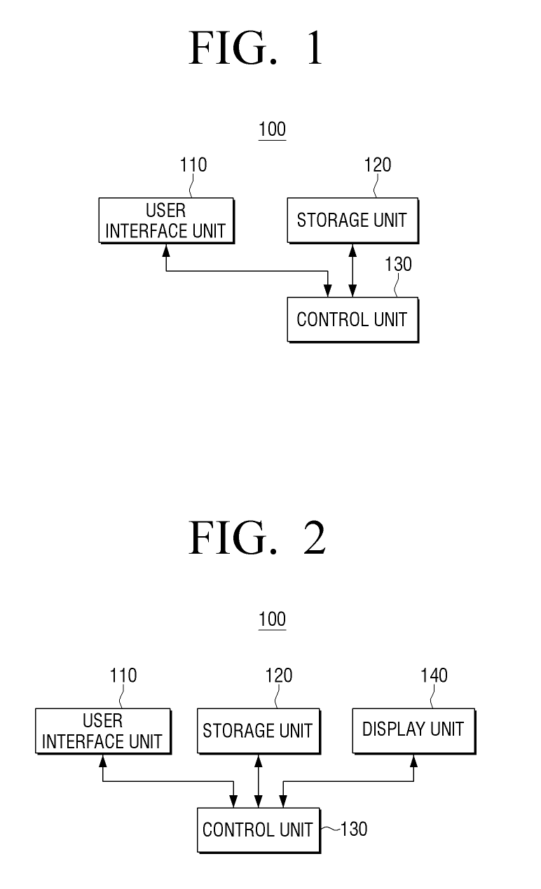

FIG. 1 is a block diagram illustrating a configuration of a terminal device according to an exemplary embodiment.

Referring to FIG. 1, a terminal device 100 includes a user interface unit 110, a storage unit 120, and a control unit 130. Here, the terminal device 100 is a terminal device configured not to support multitasking. A platform of the terminal device 100 can not execute two applications simultaneously, and when the other application is executed during execution of the one application, the platform terminates one application which has been being executed and executes the other application.

The terminal device 100 may be implemented with various terminal devices such as a television (TV), a personal computer (PC), a smart phone, a personal digital assistant (PDA), a portable multimedia player (PMP), a MP3 player, or a laptop PC.

The user interface unit 110 receives a user's command In particular, the user interface unit 110 may receive the user's command for the application being driven. The user interface unit 110 may be implemented with various input devices such as a keyboard (including an on screen keyboard (OSK)), a mouse, a touch pad, a touch screen, a pointing device, a trackball, a tablet, or a joystick. The user interface unit 110 may be implemented to be included in the terminal device 100 or with a device separate from the terminal device 100.

The storage unit 120 stores a user's command input for an application. Specifically, the storage unit 120 may store the input user's command in an order of input when the user's command for an application being executed is input though the user interface unit 110.

Here, the storage unit 120 may store a key input value when the user's command for the application is a key input, and a corresponding coordinate value when the user's command for the application is a pointing or touch input. Alternatively, the storage unit 120 may store a key input value or a coordinate value when the user's command is an OSK input.

Further, the storage unit 120 may store a result value to which the input value of the user's command is applied in addition to the input value of the user's command itself such as the key input value or the coordinate value.

For example, when the user drives a photo-viewing application, several folders may be displayed according to the first driving of the application. At this time, the user may touch a touch screen to select the first folder and input a specific coordinate value. In this case, the storage unit 120 may store the coordinate value according to the user's touch input, and store a selection command of the first folder which is a result value to which the coordinate value is applied.

Further, when the user's commands for a plurality of applications are input, the storage unit 120 may store the respective user's command input for the applications. For example, when the user sequentially executes a web browser application, a music-listening application, and a moving image reproduction application, the storage unit 120 may store the user's command input for each application. Each application may have a unique application identification (ID), and the storage unit 120 may store the user's command input for each application according to each application ID.

Further, when a page loading operation is necessary according to the user's command for the application input through the user interface unit 110, the storage unit 120 may store page loading information together with the user's command. Here, the term “page loading” denotes an operation of transmitting/receiving data for providing a new screen or information according to the user's command.

When the terminal device is connected to a new webpage through a hyperlink during execution of a web browser application, the page loading for receiving information for the new webpage may be necessary. In this case, the storage unit may store the page loading information for the new webpage together with the user's command which clicks or touches the hyperlink.

Alternatively, the storage unit 120 may store data information generated during execution of an application to be available during execution of another application.

For example, when the user may send specific text information to a friend by e-mail during web surfing, the user may store text information displayed in the webpage to the storage unit 120, execute a mail application, and use the stored text information as it is. Therefore, the terminal devices according to the exemplary embodiment can support data transfer between applications.

The exemplary embodiment has illustrated that the storage unit 120 stores all user's command and data information, but a storage unit configured to store the data information and a storage unit configured to store the user's command may be implemented with separate storage devices.

The control unit 130 controls an overall operation of the terminal device 100. Specifically, the control unit 130 may control the user interface unit 110 and the storage unit 120 to perform corresponding operations.

When an application is terminated and then driven again, the control unit 130 may control the application to be automatically executed by sequentially applying the stored user's commands. In particular, when the application being executed is automatically terminated due to execution of another application and then driven again, the control unit 130 may control the application to be automatically executed by sequentially applying the stored user's command.

The control unit 130 may control the application to be automatically executed up to a state just before the application is terminated by sequentially applying the stored user's command The phrase “state just before the application is terminated” denotes an operation state of the application just before the application is terminated when the application is terminated by the user's command or execution of another application during execution of the application. Therefore, the terminal device 100 may provide the result similar to a device that performs multitasking, to the user, even when the terminal device does not support multitasking.

When the page loading information is stored together with the user's command for the application, the control unit may check the stored page loading information, and control the application to be automatically executed by applying the user's next command when the page loading is completed.

FIG. 2 is a block diagram illustrating a configuration of a terminal device according to another exemplary embodiment.

Referring to FIG. 2, a terminal device 100 may further include a display unit 140 in addition to a user interface unit 110, a storage unit 120, and a control unit 130.

The display unit 140 displays an application execution screen. Further, the display unit 140 may display an icon corresponding to at least one application, which has been previously executed, according to a preset event.

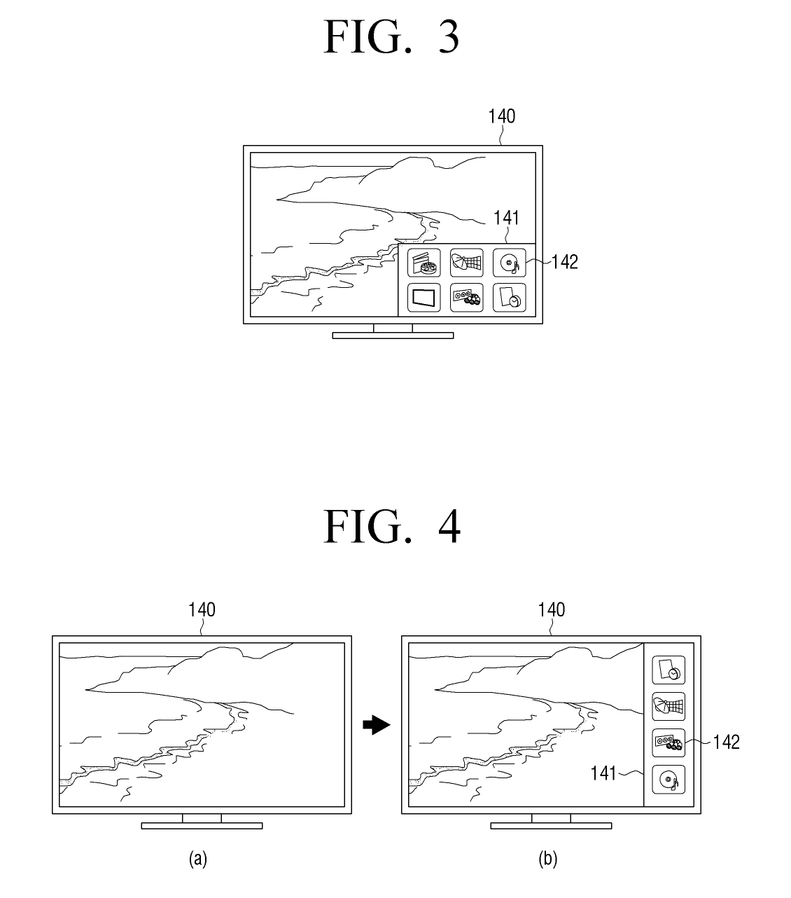

An operation of the display unit will be specifically described with reference to FIGS. 3 and 4.

FIG. 3 is a view illustrating an operation of a display unit according to an exemplary embodiment. Referring to FIG. 3, the display unit 140 includes a display screen 141 configured to display at least one icon 142, in addition to the application execution screen.

The display screen 141 may occupy a partial area of the whole display screen of the display unit 140 to display the icon 142 corresponding to the at least one application previously executed. Here, when the user inputs the user's command for selecting any one of the icons, the control unit 130 drives an application corresponding to the selected icon again. Therefore, the control 130 may control the application to be automatically executed by sequentially applying the stored user's command for the application corresponding to the selected icon.

When the user's commands for the plurality of applications are stored, the control unit 130 may sequentially apply the user's command input for the corresponding application using an application ID of the re-driven application, that is, the application corresponding to the selected icon.

FIG. 4 is view illustrating an operation of a display unit according to another exemplary embodiment. Referring to (a) of FIG. 4, the display unit 140 displays an application execution screen. At this time, when the preset event is generated, the display unit 140 displays the display screen 141 including the icon 142 corresponding to the at least one application previously executed, in the partial area of the whole display screen (see (b) of FIG. 4).

Here, the preset event may be the user's command for displaying the display screen 141 including the icon 142. Specifically, the preset event may be generated when the user inputs a specific button through the user interface unit 110, when the users input a touch input of a preset pattern or a touch input of a preset area, or when the user places a mouse in a specific area if the mouse is used.

As described in FIG. 3, when the user inputs the user's command for selecting any one icon, the control unit 130 drives the application corresponding to the selected icon again. Therefore, the control unit 130 may control the application to be automatically executed by sequentially applying the stored user's command stored for the application corresponding to the selected icon.

Further, when the application is driven again and then the stored user's command is sequentially applied, the control unit 130 may sequentially provide the application execution screens according to the application of the user's command to the user. Here, when the user does not want to receive an execution state just before the application is terminated, but an execution state in an intermediate stage, the user may input an execution stop command while the application execution screens are sequentially provided. When the execution stop command is input, the application of the stored user's command may be interrupted in the intermediate stage. Therefore, the user may receive the execution state just before the application is terminated as well as the execution state in the intermediate stage according to the situation.

The control unit 130 may provide a screen indicating “during loading” to the user and provide only the final application execution screen after application of the final user's command is completed.

The control unit 130 may control a message for inquiring whether or not to automatically execute the application to be output according to the user's command for the application stored in the storage unit 120.

When the user inputs the user's command to agree to the automatic execution of the application, the control unit 130 may sequentially apply the stored user's command as described above, and when the user inputs the user's command to not agree to the automatic execution, the control unit 130 does not apply the stored user's command, but provides the first application execution screen according to the application being driven.

Hereinafter, an operation of the terminal device through a specific example will be described.

For example, the user drives a photo-viewing application in the terminal device 100. Thus, the terminal device 100 may display a plurality of folders including photographed photo data as the first application execution screen. Here, when the user inputs the user's command for flicking the touch screen to the left so as to view a folder of the next page, the storage unit 120 may store a coordinate value according to the flicking operation or a page-moving command to the left and also store page loading information according to provision of a second page. Therefore, when the user inputs the user's command for tapping an area corresponding to a first folder so as to select the first folder in the provided second page screen, the storage unit 120 may store coordinate information according to the tapping operation of the user or a selection command for the first folder. Accordingly, the terminal device 100 provides a plurality of pieces of photo data included in the first folder of the second page in a thumbnail image, and the control unit 130 stores the page loading information according to the loading of a screen which provides the thumbnail image. Here, the user may select an icon corresponding to a web browser application in the display screen 141 so as to execute web surfing, and execute the web browser application after the photo-viewing application is terminated.

The user may drive the photo-viewing application again so as to view the photo after the web surfing, and the control unit 130 may output the message for inquiring whether or not to automatically execute the application according to the user's command when the photo-viewing application is driven again. When the user's command for the agreement is input, the control unit 130 applies the coordinate value corresponding to the flicking operation which is the user's first command in the first application execution screen in which the plurality of folder are displayed. Thus, a folder screen of the second page is displayed, and the control unit 130 checks the page loading information stored together with the user's first command and applies the coordinate value corresponding to the tapping operation which is the user's second command after provision of the folder screen of the second page is completed. Therefore, the screen providing the thumbnail image is displayed.

The operation of sequentially applying the stored user's command and automatically executing the application may be very quickly executed according to control of the control unit 130. Therefore, the user may receive the application execution screen faster than when the user directly inputs the user's command and a function is executed in a manner similar to a terminal device which performs multitasking.

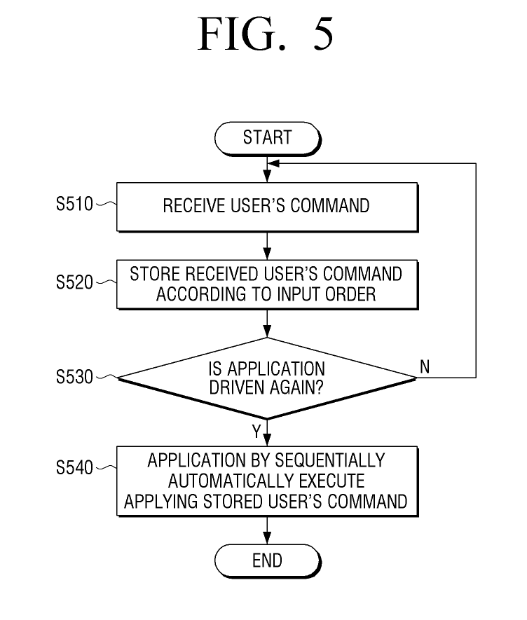

FIG. 5 is a view illustrating a method of controlling a terminal device according to an exemplary embodiment.

Referring to FIG. 5, the terminal device 100 receives a user's command (S510). In particular, the terminal device 100 may receive the user's command for an application being executed. The terminal device 100 stores the user's commands for applications according to an order of input (S520). Specifically, the storing in step S520 may include storing a key input value when the user's command for the application is a key input and storing a corresponding coordinate value when the user's command for the application is a pointing or touch input. Here, the storing in step S520 may include storing page loading information together with the user's command when a page loading operation is necessary according to the received user's command for the application.

Next, when the application is terminated and then driven again (S530-Y), the terminal device 100 controls the application to be automatically executed by sequentially applying the stored user's command (S540). In particular, the controlling in step S540 may include controlling the application to be automatically executed by sequentially applying the stored user's command when the application is automatically terminated by execution of another application and then driven again. Therefore, the application may be controlled to be automatically executed up to the state just before the application is terminated.

Further, when the page loading information is stored together with the user's command, the controlling in step S540 may include checking the stored page loading information and controlling the application to be automatically executed by applying the user's next command after the page loading is terminated.

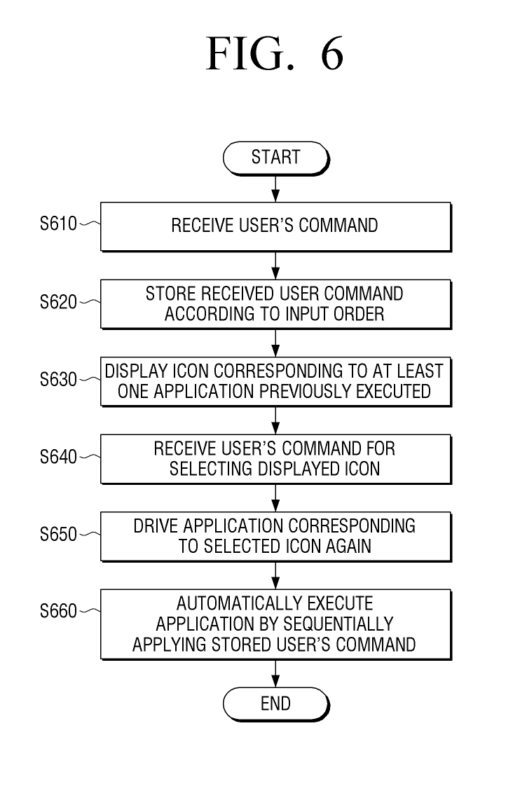

FIG. 6 is a view illustrating a method of controlling a terminal device according to another exemplary embodiment.

Referring to FIG. 6, the terminal device 100 receives a user's command (S610). In particular, the terminal device 100 may receive the user's command for an application being executed. Further, the terminal device stores the user's commands input for the applications according to an order of input (S620). Here, when the user's commands for a plurality of applications are input, the terminal device 100 may store the user's commands input for the applications. Next, the terminal device 100 displays an icon corresponding to at least one application previously executed (S630). Here, when the user's command for selecting the displayed icon is input (S640), the terminal device 100 drives the application corresponding to the selected icon again (S650). Then, the terminal device 100 automatically executes the application by sequentially applying the stored user's command (S660).

The methods of controlling the terminal device according to the above-described various exemplary embodiments may be implemented with programs executable in the terminal device. Specifically, the above-described methods may be implemented with various types of widgets or applications executable in the terminal device 100. The program may be stored and used in various types of recording mediums.

Specifically, the code for executing the above-described methods may be stored in various types of nonvolatile recording mediums such as a flash memory, a read only memory (ROM), an erasable programmable ROM (EPROM), an electrically erasable and programmable ROM (EEPROM), a hard mask, a removable disc, a memory card, a universal serial bus (USB) memory, a compact disc (CD)-ROM.

The foregoing exemplary embodiments and advantages are merely exemplary and are not to be construed as limiting the present inventive concept. The exemplary embodiments can be readily applied to other types of devices. Also, the description of the exemplary embodiments is intended to be illustrative, and not to limit the scope of the claims, and many alternatives, modifications, and variations will be apparent to those skilled in the art.

What is claimed is:

1. A terminal device, comprising:
a user interface configured to receive a command of a user for an application being executed;
a storage configured to store the command, input for the application according to an order of input; and
a controller configured to control the application to be automatically executed by sequentially applying the stored command when the application is terminated and then executed again.

2. The terminal device as claimed in claim 1, wherein the controller controls the application to be automatically executed by sequentially applying the stored command when the application is terminated by execution of another application and then executed again.

3. The terminal device as claimed in claim 1, wherein the storage stores page loading information together with the command when a page loading operation is necessary according to the received command for the application,
the controller checks the stored page loading information, and controls the application to be automatically executed by applying a next command of the user after the page loading operation is completed.

4. The terminal device as claimed in claim 1, wherein the storage stores a key input value when the command for the application is a key input and stores a corresponding coordinate value when the command for the application is one of a pointing input and touch input.

5. The terminal device as claimed in claim 1, further comprising a display unit configured to display an application execution screen,
wherein the controller displays an icon corresponding to at least one application previously executed at the display unit according to a preset event, and drives an application corresponding to an icon selected again when the user selects the displayed icon.

6. The terminal device as claimed in claim 1, wherein the controller controls the application to be automatically executed up to a state just before the application is terminated by sequentially applying the stored command.

7. The terminal device as claimed in claim 1, wherein the storage stores data information generated during the execution of the application, the data information being available during execution of another application.

8. The terminal device as claimed in claim 1, wherein the terminal device is configured not to support multitasking.

9. A method of controlling a terminal device, the method comprising:
receiving a first command of a user for an application being executed;
storing the first command input for the application according to an order of input; and
controlling the application to be automatically executed by sequentially applying the stored first command when the application is terminated and then executed again.

10. The method as claimed in claim 9, wherein the controlling includes controlling the application to be automatically executed by sequentially applying the stored first command when the application is automatically terminated by execution of another application and then executed again.

11. The method as claimed in claim 9, wherein the storing comprises storing page loading information together with the first command when a page loading operation is necessary according to the received first command for the application,
the controlling comprises checking the stored page loading information and controlling the application to be automatically executed by applying a next command of the user after the page loading operation is completed.

12. The method as claimed in claim 9, wherein the storing includes storing a key input value when the first command for the application is a key input and storing a corresponding coordinate value when the command for the application is one of a pointing input and a touch input.

13. The method as claimed in claim 9, further comprising:
displaying an icon corresponding to at least one application previously executed according to a preset event;
receiving a second command of a user for selecting the displayed icon; and
executing an application corresponding to the selected icon.

14. The method as claimed in claim 9, wherein the controlling comprises controlling the application to be automatically executed up to a state just before the application was terminated, by sequentially applying the stored first command when the application is executed again.

15. The method as claimed in claim 9, further comprising storing data information generated during the execution of the application to be available during execution of another application.
